(19) United States
(12) Patent Application Publication
(10) Pub. No.: US 2003/0036352 A1
(43) Pub. Date: Feb. 20, 2003

(54) Embedded e-marker and communication system

(75) Inventor: Yuichiro Deguchi, San Mateo, CA (US)

Correspondence Address: Valley Oak Law, 5665 Silver Creek Valley Rd. #106, San Jose, CA, 95138, US

(73) Assignee: Sony Corporation

(21) Appl. No.: 09/932,621

(22) Filed: Aug. 17, 2001

(51) Int. Cl. H04B 5/00

(52) U.S. Cl. 455/41

(57) ABSTRACT

Method and system for providing a wireless communication system including a data marker integrated device capable of wireless communication to a network device which is configured to establish a connection to the server terminal for transmission of the received data marks from the data marker integrated device, where the connection between the network device and the server terminal may include secure wireless connection.

### FIELD OF THE INVENTION

The present invention relates to portable electronic music marker devices. More particularly, the present invention relates to electronic music marker integrated device communication system.

### BACKGROUND OF THE INVENTION

With increase in portable electronic devices such as personal digital assistants (PDAs), WAP (Wireless Application Protocol) enabled mobile telephones, i-mode mobile telephones, multi-functional portable radio CD (Compact Disc) players, MD (Mini Disc) players and MP3 music players, there has been a steady increase in these types of devices capable of performing more operations.

Sony Corporation and its U.S. subsidiary, Sony Electronics, Inc., introduced an electronic music marker device which is capable of “bookmarking” a music clip while being played on a radio and is capable of recalling the information related to the bookmarked music clip such as the name of the song, the artist, the album containing the song and so on. Using the electronic music marker device, a user can conveniently access the music clip information that the user listened to on the radio at a later time without the need to memorize the information or wait hopefully for the disc jockey on the radio to provide that information. In this manner, if the user wants to, for example, purchase the music album which the user has marked using the electronic music marker device, the user can easily identify the necessary information related to the marked music clip from the e-marks provided by the electronic music marker device.

While the electronic music marker device is introduced as a portable device which can easily be attached to a user's key chain, worn around a user's neck or attached to the strap of a user's bag for ready and convenient access, it would be desirable to incorporate the functionality of the electronic music marker device into existing electronic devices. Moreover, it would be desirable to have a communication system which includes electronic devices integrated with electronic music marker device functionality that are capable of wireless communication with network devices such as internet access enabled mobile telephone and the like, which in turn, may be configured to transmit the bookmarked data to the electronic music marker device server terminal. Furthermore, it would be desirable to allow the user to be able to access information related to the bookmarked data from a user terminal without the need to retransmit the bookmarked data to the server terminal.

### SUMMARY OF THE INVENTION

In view of the foregoing, a marker integrated device communication system includes a data marker integrated device configured to store one or more data marks, a network device configured to establish wireless communication with the data marker integrated device to receive the one or more data marks from the data marker integrated device, and a server terminal configured to connect to the network device for data communication.

A method of another embodiment includes receiving one or more stored data marks via a wireless communication path, establishing a connection to a server terminal, and transmitting the received one or more data marks using the established connection.

A method of a further embodiment includes storing a data mark, transmitting the stored data mark via a Bluetooth protocol connection, receiving the transmitted data mark, and transmitting the received data mark via a wireless connection.

A data marker integrated device communication system of still another embodiment includes means for receiving one or more stored data marks via a wireless communication path, means for establishing a connection to a server terminal, and means for transmitting the received one or more data marks using the established connection.

A data marker integrated device communication system of yet still another embodiment includes means for storing a data mark, means for transmitting the stored data mark via a Bluetooth protocol connection, means for receiving the transmitted data mark, and means for transmitting the received data mark via a wireless connection.

These and other features and advantages of the present invention will be understood upon consideration of the following detailed description of the invention and the accompanying drawings.

### BRIEF DESCRIPTION OF THE DRAWINGS

FIG. 1 illustrates one embodiment of an overall embedded data marker device communication system;

FIG. 2 illustrates one embodiment of a marker integrated device of FIG. 1;

FIG. 3 illustrates one embodiment of a network device of FIG. 1;

FIG. 4 illustrates one embodiment of a server terminal of FIG. 1;

FIG. 5 is a flowchart for illustrating one embodiment of the embedded electronic music marker device communication system operation;

FIG. 6 is a flowchart for illustrating another embodiment of the embedded electronic music marker device communication system operation; and

FIG. 7 is a flowchart for illustrating yet another embodiment of the embedded electronic music marker device communication system operation.

### DETAILED DESCRIPTION

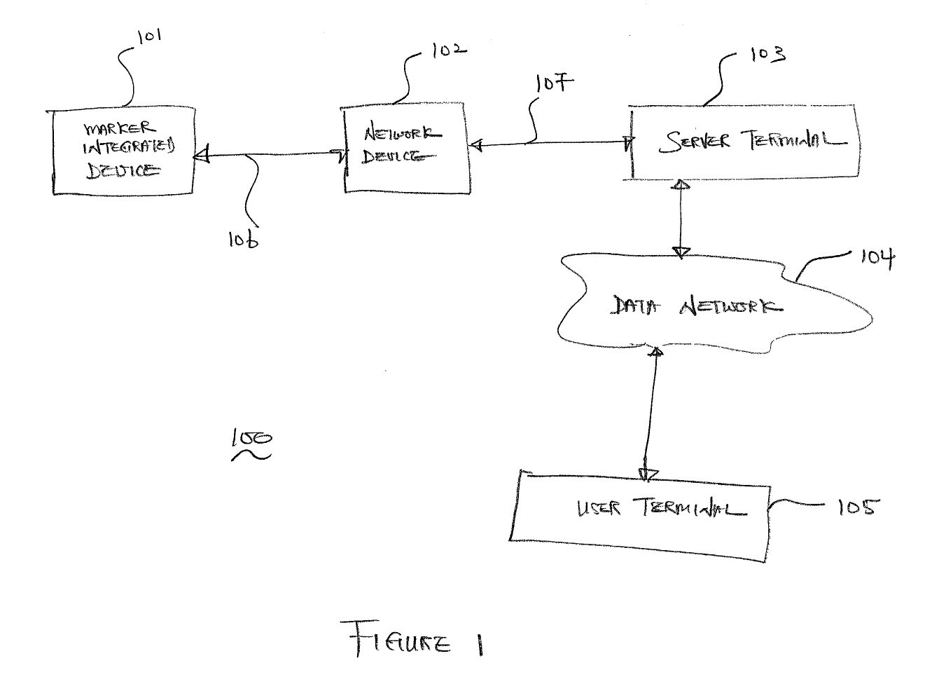

FIG. 1 illustrates one embodiment of an overall embedded data marker device communication system. Referring to FIG. 1, embedded data marker device communication system 100 includes marker integrated device 101 configured to communicate with network device 102 via a local wireless connection 106 under communication protocol such as Bluetooth protocol. Further shown in FIG. 1 are server terminal 103 configured to communicate with network device via connection 107. Server terminal 103 is further configured to communicate with user terminal 105 as shown via data network 104.

In one aspect, marker integrated device 101 includes an integrated Bluetooth communication port for communicating with other devices which are Bluetooth protocol communication enabled. Likewise, network device 102 includes an integrated Bluetooth communication port for communicating with device such as marker integrated device 101 for data transfer. As shown, connection 106 includes a short range wireless communication path between marker integrated device 101 and network device 102. In one embodiment, marker integrated device 101 may include automobile radio, a portable electronic devices such as Walkman®, MD® player. MP3 player each of which have incorporated and integrated therein the functionality of electronic data marker device. Additional detailed information relating to the operation of the electronic music marker devices can be found in pending application Ser. No. 09/126,007 filed on Jul. 29, 1998 and application Ser. No. 09/401,105 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

Referring back to FIG. 1, network device 102 in one embodiment may include Wireless Application Protocol (WAP) enabled mobile telephones, i-mode telephones, internet access enabled personal digital assistants (PDAs), and the like, each of which is capable of establishing internet connection protocol for data transfer. Additionally, network device 102 is configured with an integrated Bluetooth communication port for communicating with marker integrated device 101.

Server terminal 103 shown in FIG. 1 may be configured to communicate with network device 102 via wireless connection 107 for data transfer, and may operate, for example, at communication speeds such as 56 Kbps (similar to a wired dialup modem connection) or higher such as that available from Ricochet® devices from which allow PDAs to establish wireless communication for connection to the internet at speeds exceeding 56 Kbps.

In this manner, network device 102 may be configured to receive data from marker integrated device 101 such as user inputted data marks and marker device identification code for the user via the wireless Bluetooth connection 106, for example, and to transmit the received data via wireless connection 107 to server terminal 103.

Referring back to FIG. 1, data network 104 may include an IP network configured to connect server terminal 103 to user terminal 105 using protocols such as TCP/IP, Appletalk and the like. User terminal 105 may include a personal desktop computer, a portable laptop computer, an internet appliance with internet access capability, and the like. Moreover, user terminal 105 may be connected to server terminal 103 via data network 104 using one of a dialup modem connection, a DSL modem connection, a cable modem connection, and a wireless modem connection, each offering varying connection speeds for data upload and download.

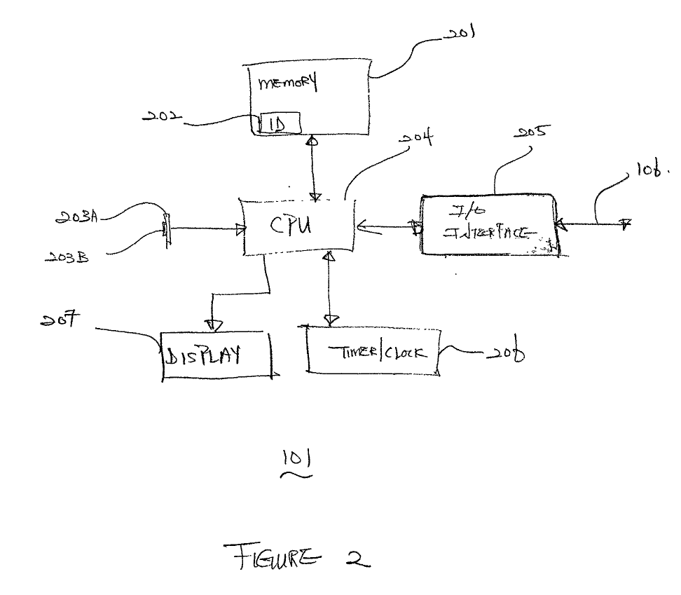

FIG. 2 illustrates one embodiment of a marker integrated device of FIG. 1. Referring to FIG. 2, marker integrated device 101 includes memory 201 such as a Random Access Memory (RAM) and a Read-Only Memory (ROM), and stored thereon is a unique device identification code 202 which can include a predetermined combination of letters or numbers, or a combination of both. In one embodiment, identification code 202 can include a thirteen-digit number which is unique to each bookmarking device and is pre-stored in the ROM portion of memory 201.

Further shown in FIG. 2 is controller (CPU) 204 which is configured to control the various components of marker integrated device 101 as related to the data marking device functionality such as display unit 207, input units 203A, 203B data marking buttons for bookmarking broadcast music clips over a registered radio or television station, or for bookmarking locations, input/output (I/O) interface unit 205, clock/timer 206, and memory 201. In one aspect, display unit 207 and timer/clock 206 of marker integrated device 101 may be the corresponding display terminal and clock unit, respectively, of the marker integrated device. For example, in the case of an automobile radio with data marker integrated therein as marker integrated device 101, display unit 207 may be integrated with the existing display panel of the automobile radio, and timer/clock 206 may be integrated with the existing radio clock in the device 101.

Referring back to FIG. 2, I/O interface unit 205 of marker integrated device 101 may include a Bluetooth communication port for wireless data communication which is a radio frequency standard operating at 2.4 GHz for short range wireless communication. More specifically, I/O interface unit 205 may include a Bluetooth enabled transceiver and communication port for communicating with other Bluetooth enabled devices such as network device 102 over the designated operating frequency. In one aspect, I/O interface 205 may be configured to, under the control of controller 204, communicate with server terminal 105 and marker integrated device 101.

Display unit 207 in one embodiment may include a liquid crystal display (LCD), a plasma-type display, and the like, configured to display text or image data, or a combined text and image data. Furthermore, as discussed above, the input units 203A, 203B may include spring-loaded type input buttons for operation by the user's finger, and integrated, for example, on the front panel of marker integrated device 101 for quick and convenient access by the user. In one aspect, input units 203A, 203B may be integrated with the existing input buttons on marker integrated device 101 such as, for example, preset radio station buttons on an automobile radio. Furthermore, timer/clock 206 may be configured to provide actual time information or generate an elapsed time information depending upon the input command from the user under the control of controller 204.

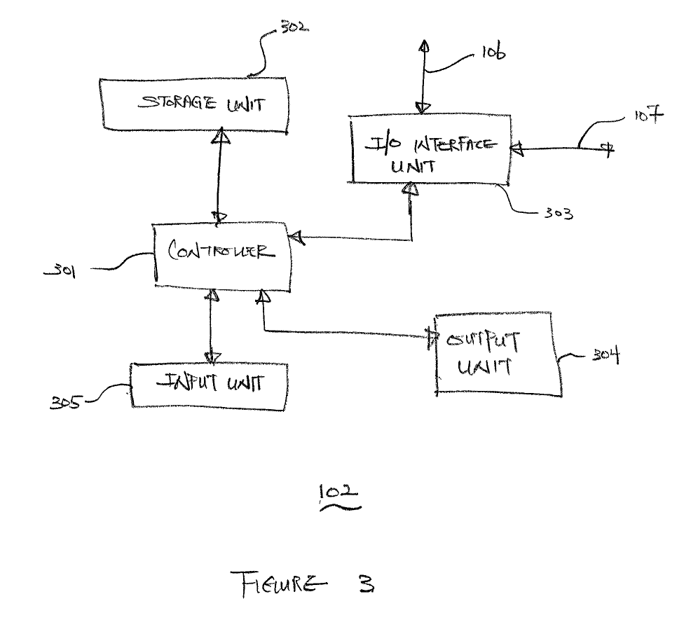

FIG. 3 illustrates one embodiment of a network device of FIG. 1. As discussed above, network device 102 may include WAP enabled mobile telephones, i-mode telephones, and internet access enabled PDAs which have integrated therein, in one embodiment, the various components discussed hereinbelow. Referring to FIG. 3, network device 102 in one embodiment includes controller 301 coupled to storage unit 302. Also coupled to controller 301 are input unit 305, output unit 304, and I/O interface unit 303. In one aspect, I/O interface unit 303 may include a Bluetooth enabled transceiver and communication port for communicating with Bluetooth enabled devices under the Bluetooth communication protocol. More specifically, I/O interface unit 303 may be configured to interface with marker integrated device 101 via connection 106 for data transfer under the Bluetooth wireless communication protocol, as well as wirelessly communicating with server terminal 103 using, for example, WAP protocol or i-mode communication protocol.

Referring back to FIG. 3, storage unit 302 may be configured to store data received from marker integrated device 101 as well as for storing data received from server terminal 103. Additionally, controller 301 may be configured to update data stored in storage unit 302 based on user input command via input unit 305. Furthermore, output unit 304 which may include a Liquid Crystal Display, a plasma display unit and the like, may be configured to display data such as communication progress status, data connection status, received and/or generated messages, and the like.

Additionally, in one aspect, input unit 305 and output unit 304 of network device 102 may be integrated with the device input unit and output unit such that additional design modification to existing network devices can be avoided. For example, in the case of network device 102 including a WAP enabled mobile telephone, output unit 304 may be integrated with the existing display panel of the mobile telephone, while input unit 305 may be integrated with the existing numeric buttons provided thereon.

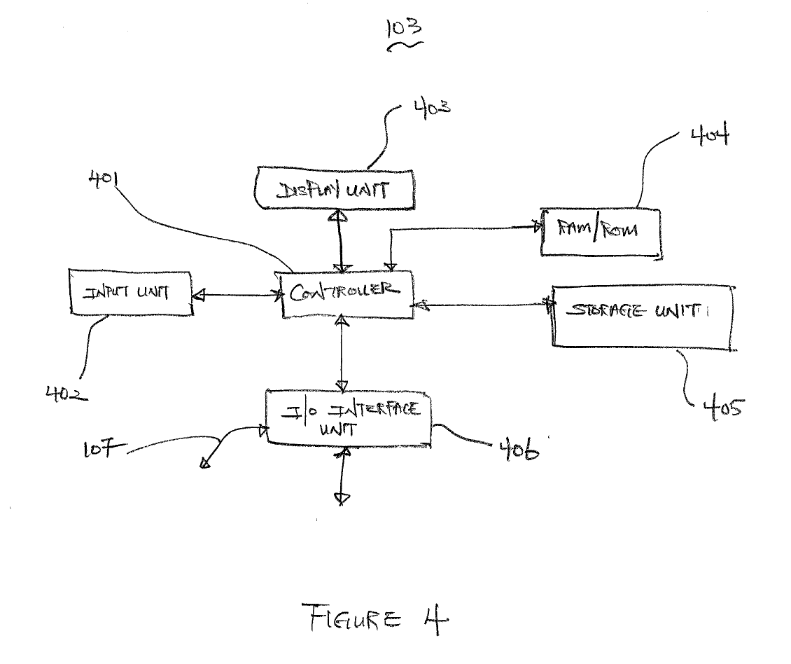

FIG. 4 illustrates one embodiment of a server terminal of FIG. 1. Referring to FIG. 4, server terminal 103 includes controller 401, input unit 402, display unit 403, RAM/ROM 404, storage unit 405 and I/O interface unit 406. As shown, controller 401 is coupled to input unit 402 and display unit 403 for receiving input signals and controlling the output display, respectively, of server terminal 103. Controller 401 is further configured to access RAM/ROM 404 to retrieve data stored thereon for performing executable processings while, controller accesses 405 storage unit 405 to retrieve data such as user playlist data, user account information, playlist information, and the like based on data marks received as discussed in further detail below.

In one aspect, I/O interface unit 406 is configured for wireless communication with, for example, network device 102 such that server terminal 103 may transmit and receive data under wireless communication protocol to network device 102. Furthermore, in one aspect, controller 401 may be configured to encrypt and decrypt data transmitted and received from network device 102 under wireless communication channel such that data may be securely transmitted and received.

Moreover, as discussed above, server terminal 103, under the control of controller 401 may be configured to communicate with user terminal 105 via data network 104. Depending upon the type of data received from user terminal 105, controller 401 may be configured to selectively access storage unit 405 to retrieve information stored thereon in response to the received data, or to update the stored data in storage unit 405 based on the received data. Additionally, controller 401 may be configured to receive playlist information from playlist provider (not shown) periodically, or at predetermined time frames, and to store the received playlist information in storage unit 405.

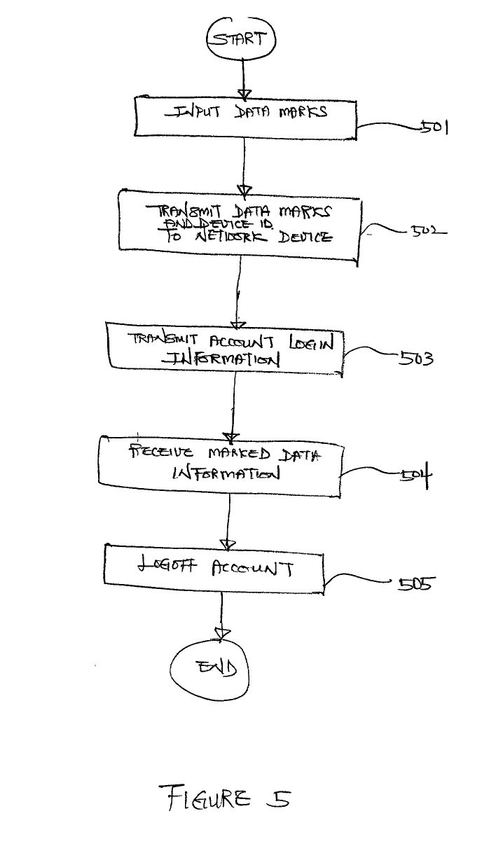

FIG. 5 is a flowchart for illustrating one embodiment of the embedded data marker device communication system operation. Referring to FIG. 5, at step 501, a user inputs data marks using input units/buttons 203A, 203B of marker integrated device 101 for bookmarking data such as desired music clip broadcast over a registered radio or television station. After one or more input data marks, data marks and user device ID are transmitted to network device 102 via wireless Bluetooth connection 106. As will be discussed in further detail below, network device 102 may then be configured to establish wireless connection to server terminal 103 for transmitting received data marks and user's device ID.

Referring back to FIG. 5, at step 503, the user transmits account login information from user terminal 105 to access user's account at server terminal 103. It should be noted that in one embodiment, a substantial time lag exists between step 502 of transmitting data marks and device ID to network device 102 and step 503 where user's account login information is transmitted from user terminal 105 to server terminal 103 via data network 104. Thereafter at step 504, information corresponding to transmitted data marks are received at user terminal 105 from server terminal 103, where the data marks were transmitted from marker integrated device 101. Finally, the user may logoff the user's account at step 505, completing the procedure.

In this manner, using marker integrated device 101, users may conveniently bookmark data such as broadcast music clips over registered radio stations and television stations, and wirelessly transmit the marked data relatively contemporaneous to storing (or inputting) data marks in marker integrated device 101, and thereafter, via user terminal 105 such as a personal computer and the like, retrieve information corresponding to the marked data such as, in the case of marked broadcast music clips, information related to the marked music clips including the name of the music album, the name of the artist of the marked music clips, the purchase information for the purchase of the music album, and the like.

Additionally, since the functionality of the electronic data marking device is integrated into electronic devices such as car radios, portable music playback devices which are further enabled for wireless communication with network device 102, a much robust data marking system is possible.

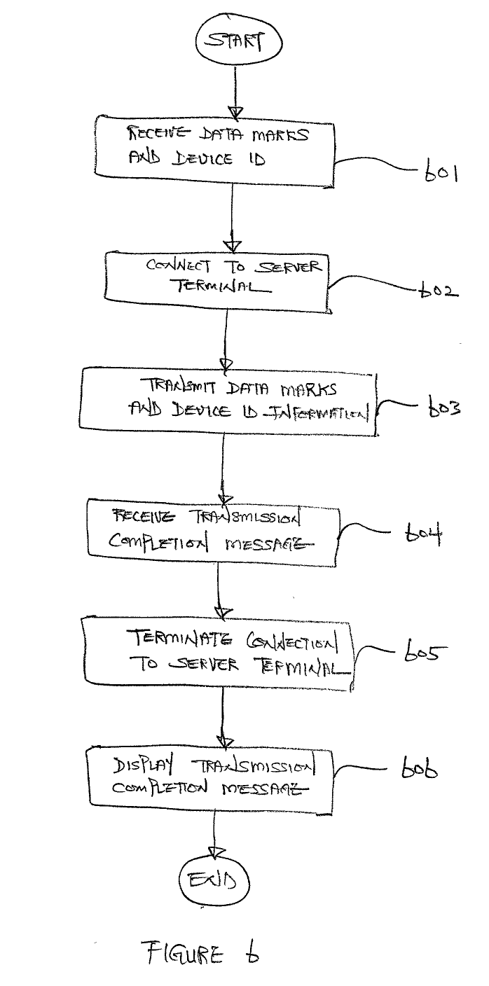

FIG. 6 is a flowchart for illustrating another embodiment of the embedded data marker device communication system operation. Referring to FIG. 6, at step 601, data marks and device ID are received by network device 102 from marker integrated device 101 via wireless connection 106. Thereafter at step 602, network device 102 is configured to establish connection to server terminal 103 which may be over a wireless communication data path such as connection 107. At step 603, with the connection established between network device 102 and server terminal 103, network device 102 is configured to transmit data marks and device ID information received from marker integrated device 101.

Once data transmission from network device 102 to server terminal 103 is completed, at step 604, network device 102 receives a transmission complete message from server terminal 103, and thereafter, at step 605, terminates the connection to server terminal 103. After terminating the connection to server terminal 103, network device 102 at step 606 displays transmission completed message received from server terminal 103 on output unit 304 (FIG. 3) which in one embodiment may include a display unit such as a liquid crystal display unit, a plasma display unit or the like. In this manner, the user may conveniently be informed as to the transmission status, and the completion of data transmission to server terminal 103.

Additionally, network device 102 may be configured to transmit transmission completion message to marker integrated device 101, which, upon receiving the transmission completion message, may be configured to delete the stored data marks to allow the user to input additional data marks. In this manner, data marks stored (or input) to marker integrated device 101 may be transmitted to network device 103 for transmission to server terminal 103, such that marker integrated device 101 need not be designed with a large capacity memory for storing a significant number of data marks, and further, frequent transmission of marked data is possible without the need to use a gateway terminal (for example, user terminal 105) for transmitting marked data.

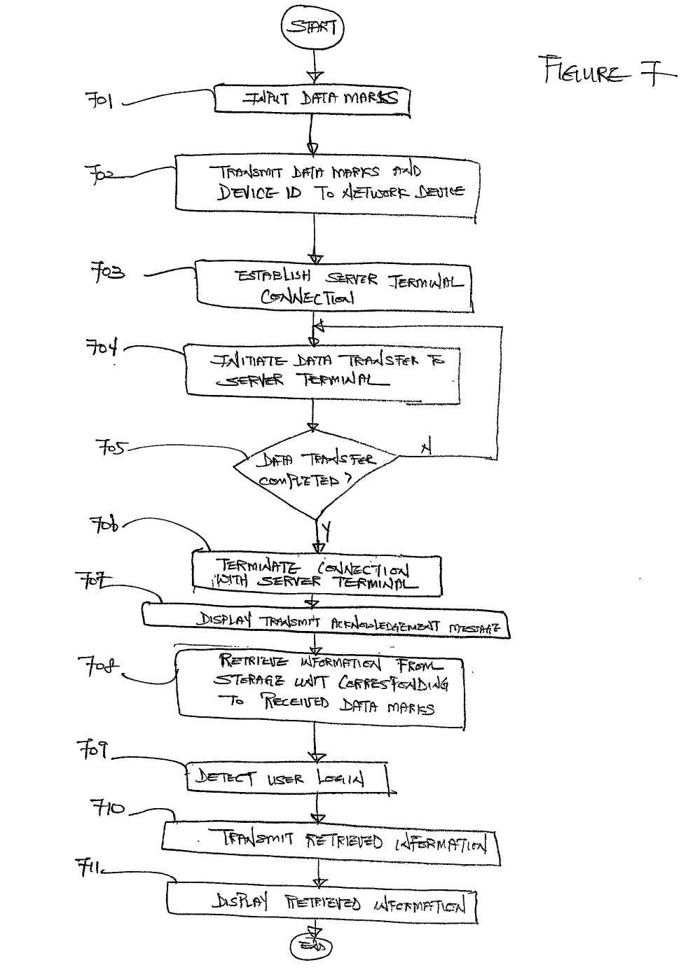

FIG. 7 is a flowchart for illustrating a further embodiment of the embedded data marker device communication system operation. Referring to FIG. 7, at step 701 user inputs desired data marks in marker integrated device 101, and at step 702, the inputted data marks are transmitted to network device 102 along with user device ID. Thereafter at step 703, network device 102 establishes connection to server terminal 103. With the connection to server terminal 103 established, network device 102 initiates data transfer to server terminal 103, the transmitted data including received data marks and device ID, for example. At step 705, it is determined whether the data transmission from network device 102 to server terminal 103 is completed. If the data transmission from network device 102 to server terminal 103 is not completed, then the procedure returns to step 704. On the other hand, if at step 705 it is determined that data transfer from network device 102 to server terminal 103 is completed, then at step 706 network device 102 terminates its connection with server terminal 103. Optionally, network device 102 may encrypt data for transmission to server terminal 103 prior to executing data transfer. in this case, server terminal 103 may be configured to decrypt the encrypted data received from network device 102.

Referring back to FIG. 7, after terminating the connection to server terminal 103 at step 706, at step 707, network device 102 is configured to display a transmit acknowledgement message on its output unit 304 (FIG. 3) to inform the user that the data transmission to server terminal 103 is completed. Alternatively, network device 102 may be configured to transmit a message to marker integrated device 101 via Bluetooth connection 106, and marker integrated device 101 may be configured to delete the stored data marks upon receiving the message from network device 102. In this manner, the user may operate marker integrated device 101 to input additional data marks as desired.

Referring again to FIG. 77, at step 708 after receiving data from network device 102 and disconnecting its connection thereto, server terminal 103 is configured to retrieve information from storage unit 405 (FIG. 4) corresponding to received data marks. For example, in the case of bookmarked music clips as data marks, server terminal 103 may be configured to query storage unit 405 to identify the corresponding music information for each data mark received from network device 102. Furthermore, server terminal 103 may be configured to retrieve user account information based on device ID received from network device 102.

Thereafter at step 709, when server terminal 103 detects a user login from user terminal 105 via data network 104, at step 710, server terminal 103 may be configured to transmit the retrieved information corresponding to the received data marks from network device 102, and to display the transmitted information at user terminal display unit. Alternatively, server terminal 103 may be configured to access storage unit 405 only after detecting the user login, and to retrieve stored information corresponding to the received data marks for transmission to user terminal 103.

In the manner described above, in accordance with the various embodiments of the present invention, the functionality of electronic data marker device such as electronic music marker devicess may be integrated with electronic devices such as car radios, portable audio playback devices, and the like. Moreover, these electronic devices may also include a Bluetooth communication port and transceiver for wireless data communication with devices with such communication ports such as network devices including, for example, WAP enabled mobile telephones, i-mode telephones, internet access enabled PDAs and the like. In this manner, bookmarked data may be easily transferred to the network devices, which, in turn, may be configured to wirelessly access the server terminal for transmitting the bookmarked data.

Moreover, users may access their electronic music marker device accounts to retrieve bookmarked music clips and related information such as music CD purchase information from user terminals connected to the server terminal. In this manner, electronic music maker integrated device communication system allows users to bookmark music clips broadcast from registered radio and television stations, and wirelessly transmit bookmarks as well as users' unique device IDs via network devices such as mobile telephones to server terminal, and thereafter, conveniently retrieve information related to the bookmarked music clips by accessing their respective electronic music marker device accounts.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A data marker integrated device communication system, comprising:
a data marker integrated device configured to store one or more data marks;
a network device configured to establish wireless communication with the data marker integrated device to receive said one or more data marks from said data marker integrated device; and
a server terminal configured to connect to said network device for data communication.

2. The system of claim 1 wherein each of said one or more data marks includes a time stamp information.

3. The system of claim 1 wherein said data marker integrated device includes one of an electronic music marker integrated radio, and an electronic music marker integrated audio playback device.

4. The system of claim 1 wherein said network device includes one of a wireless application protocol (WAP) enabled mobile telephone, an i-mode mobile telephone, and an internet access enabled personal digital assistant.

5. The system of claim 1 wherein said wireless communication between said network device and said data marker integrated device is established with Bluetooth communication protocol.

6. The system of claim 1 wherein said data marker integrated device includes an interface unit configured to establish wireless communication under Bluetooth communication protocol.

7. The system of claim 6 wherein said network device includes an interface unit configured to establish wireless communication under Bluetooth communication protocol.

8. The system of claim 7 wherein said Bluetooth communication protocol operates at approximately 2.4 GHz.

9. The system of claim 1 wherein said data marker integrated device is configured to transmit device identification code to said network device.

10. The system of claim 1 wherein said server terminal is configured to receive said one or more data marks from said network device.

11. The system of claim 10 wherein said server terminal is further configured to transmit a transmission acknowledgement message to said network device.

12. The system of claim 11 wherein said network device is configured to display said transmission acknowledgement message.

13. The system of claim 11 wherein said network device is configured to transmit said transmission acknowledgement message to said data marker integrated device.

14. The system of claim 13 wherein said data marker integrated device is configured to delete said stored one or more data marks after receiving said transmission acknowledgement message from said network device.

15. The system of claim 1 further including a user terminal configured to connect to said server terminal.

16. The system of claim 15 wherein said user terminal includes one of a desktop computer, a laptop computer, and a handheld computer.

17. The system of claim 15 wherein said user terminal is connected to said server terminal via TCP/IP protocol.

18. The system of claim 15 wherein said user terminal is configured to receive information corresponding to said one or more data marks from said server terminal.

19. The system of claim 18 wherein said information corresponding to said one or more data marks includes one or more of a name of a broadcast music clip corresponding to said one or more data marks, a name of the artist of a broadcast music clip corresponding to said one or more data marks, a name of the album of a broadcast music clip corresponding to said one or more data marks, and a purchase information for a music album corresponding to a broadcast music clip related to said one or more data marks.

20. A method, comprising:
receiving one or more stored data marks via a wireless communication path;
establishing a connection to a server terminal; and
transmitting said received one or more data marks using said established connection.

21. The method of claim 20 wherein said wireless communication path includes a wireless communication link under Bluetooth communication protocol.

22. The method of claim 20 further including receiving a device identification code via said wireless communication path.

23. The method of claim 22 further including transmitting said device identification code using said established connection to said server terminal.

24. The method of claim 20 wherein said connection includes a wireless application protocol connection.

25. The method of claim 20 further including transmitting a transmission acknowledgement message via said connection.

26. The method of claim 25 further including displaying said transmission acknowledgement message.

27. The method of claim 25 further including deleting said one or more data marks after receiving said transmission acknowledgement message.

28. The method of claim 20 further including retrieving information corresponding to said one or more data marks.

29. The method of claim 28 further including transmitting said retrieved information to a user terminal.

30. The method of claim 28 wherein said retrieved information includes one or more of a name of a broadcast music clip corresponding to said one or more data marks, a name of the artist of a broadcast music clip corresponding to said one or more data marks, a name of the album of a broadcast music clip corresponding to said one or more data marks, and a purchase information for the purchase of a music album of a broadcast music clip corresponding to said one or more data marks.

31. A method, comprising:
storing a data mark;
transmitting said stored data mark via a Bluetooth protocol connection;
receiving said transmitted data mark; and
transmitting said received data mark via a wireless connection.

32. The method of claim 31 further including receiving a device identification code via said wireless connection.

33. The method of claim 31 further including transmitting a device identification code via said wireless connection.

34. The method of claim 31 wherein said wireless connection includes a wireless application protocol connection.

35. The method of claim 31 further including receiving a transmission acknowledgement message via said wireless connection.

36. The method of claim 35 further including displaying said received transmission acknowledgement message.

37. The method of claim 31 further including deleting said stored data mark.

38. The method of claim 31 further including retrieving information corresponding to said data mark.

39. The method of claim 38 further including transmitting said retrieved information to a user terminal.

40. The method of claim 38 further including displaying said retrieved information.

41. The method of claim 38 wherein said retrieved information includes one of a name of a music clip corresponding to said data mark, a name of a music album corresponding to said data mark, a name of the artist for a music clip corresponding to said data mark, and a purchase information for the purchase of a music album corresponding to said data mark.

42. A data marker integrated device communication system, comprising:
means for receiving one or more stored data marks via a wireless communication path;
means for establishing a connection to a server terminal; and
means for transmitting said received one or more data marks using said established connection.

43. A data marker integrated device communication system, comprising:
means for storing a data mark;
means for transmitting said stored data mark via a Bluetooth protocol connection;
means for receiving said transmitted data mark; and
means for transmitting said received data mark via a wireless connection.
